(19) United States
(12) Patent Application Publication
(10) Pub. No.: US 2024/0333112 A1
(43) Pub. Date: Oct. 3, 2024

(54) Arrangement for Grounding a Component

(71) Applicant: ZF Friedrichshafen AG, Friedrichshafen (DE)

(72) Inventors: Christian Michel, Ravensburg (DE); Sven Holst, Meckenbeuren (DE); Sven Ludsteck, Münnerstadt (DE); Reinhard Deppert, Gochsheim (DE)

(21) Appl. No.: 18/616,756

(22) Filed: Mar. 26, 2024

(30) Foreign Application Priority Data
Mar. 27, 2023 (DE) 102023202771.2

(51) Int. Cl. H02K 11/40; H02K 7/00; H02K 9/193

(52) U.S. Cl. CPC H02K 11/40; H02K 7/003; H02K 9/193

(57) ABSTRACT

An arrangement (15) for grounding a component includes a grounding hub (19) that electrically conductively connects the component with a ground. The grounding hub (19) electrically conductively connected to the component at a first axial end (24). The grounding hub (19) forms an axially extending supply line (28), which opens at the first axial end (24) and along which lubricant and/or coolant is flowable in a first path to the first axial end (24). The grounding hub (19) is arranged radially inwardly of a shaft (9), which is coaxial with at least with the grounding hub (19) and is also provided with at least one recess (35) that connects the supply line (28) to an intermediate space (37). A circumferential damming edge (38) is formed on an inner diameter of the shaft (9) and axially on a side of the at least one recess (35), by which, in interaction with the intermediate space (37), a second path is formed for conducting lubricant and/or coolant from the supply line (28) via the at least one recess (35) to the first axial end (24).

### CROSS-REFERENCE TO RELATED APPLICATION

The present application is related and has right of priority to German Patent Application No. DE 102023202771.2 filed on Mar. 27, 2023, which is incorporated by reference in its entirety for all purposes.

### TECHNICAL FIELD

The invention relates generally to an arrangement for grounding a component, in particular a rotor shaft of an electric machine. The invention also relates generally to a transmission, an electric axle drive unit for a motor vehicle, and to an electric machine, in each of which an aforementioned arrangement is implemented.

### BACKGROUND

In the field of motor vehicles, electric machines are used to design the motor vehicle as a hybrid vehicle or an electric vehicle. Electric machines are also provided in some motor vehicle transmissions in order to make the motor vehicle transmission suitable for use in a hybrid vehicle or an electric vehicle. Whereas the remaining components of the transmission are enclosed and shielded by the surrounding transmission housing, the shafts which extend out of the transmission housing can induce electromagnetic interference, which, in the area of a motor vehicle, can result in a malfunction of other electronic components. In addition, a potential difference can build up between the shaft and the transmission housing, which can result in perforations on bearings of the shaft and thus to a reduction in the service life of these bearings. For this reason, the shaft concerned is to be grounded, if possible. A shaft is also to be grounded with respect to other electric machines provided in a motor vehicle, such as, for example, electric axle drive units, in order to eliminate or reduce electromagnetic interference and to prevent the build-up of a potential difference. Grounding is usually carried out by electrically conductively connecting the shaft to be grounded to a ground, which is usually a housing.

DE 10 2019 133 677 A1 describes an arrangement for grounding a rotor shaft of an electric machine, wherein the rotor shaft in this arrangement is electrically conductively connected via a tubular grounding hub to a housing, which acts as ground for grounding the rotor shaft. The grounding hub is supported at one axial end on the rotor shaft via a support bearing and is floatingly mounted at an opposite axial end in a housing cover of the housing. For the floating mounting, an electrically conductive, radially resilient intermediate element is provided radially between the grounding hub and the housing cover. The intermediate element, as a guide element, also establishes the electrically conductive connection between the grounding hub and the housing. On the rotor shaft side, an electrically conductive connection between the grounding hub and the rotor shaft is established as a sliding contact via a grounding element, which is in the form of a carbon pin. The carbon pin is mounted on the rotor shaft and guided in a carbon brush holder, which is mounted on the grounding hub. Due to sliding contact between the carbon pin and the carbon brush holder, the electrically conductive connection is established between the grounding hub and the rotor shaft. The tubular grounding hub is used, in addition for establishing the electrically conductive connection of the rotor shaft to the housing, for conducting a lubricant and coolant in the form of oil to the rotor shaft.

### BRIEF SUMMARY

Example aspects of the present invention provide an arrangement in which supplying lubricant and/or coolant to a component to be grounded is improved.

According to example aspects of the invention, an arrangement for grounding a component includes a grounding hub, via which the component to be grounded is electrically conductively connected to a ground, preferably a housing. The grounding hub is electrically conductively connected to the ground and, at a first axial end, also electrically conductively connected to the component, wherein at least some sections of the grounding hub are tubular and thereby form an axially extending supply line, which opens at the first axial end and along which lubricant and/or coolant is conductable in a first path to the first axial end. In addition, the grounding hub is arranged radially inward of a shaft, preferably a transmission shaft, which is axially superimposed and/or coaxial at least with the grounding hub.

In particular, the component, which is to be grounded, in the arrangement according to example aspects of the invention is a shaft, this shaft particularly preferably being in the form of a rotor shaft which is provided for establishing a corotational connection with a rotor of an electric machine. The rotor and the rotor shaft can also be formed in one piece or can be present as individual components which are separate and connected to one another for conjoint rotation. The electric machine can be an integral part of a motor vehicle transmission. In principle, however, the component to be grounded can also be any other type of shaft, such as, for example, a transmission shaft, or any type of, in particular rotating, component.

In the arrangement according to example aspects of the invention, the grounding hub is provided for electrically conductively connecting the component to be grounded to the ground, by way of the grounding hub being electrically conductively connected at a first axial end to the component to be grounded and also electrically conductively connected to the ground. The grounding hub includes an electrically conductive material at least in contact regions with the ground and the component to be grounded and in an intermediate region connecting these contact regions. Preferably, the grounding hub is formed entirely of an electrically conductive material, however, which is, in particular, a metal material, such as, for example, steel or aluminum.

The ground, with which the electrically conductive connection of the component to be grounded is established via the intermediate grounding hub, is, as set forth in example aspects of the invention, an electrically conductive body, to which, in particular, zero potential is assigned as reference potential. Preferably, this ground is present in the form of a housing. The electrically conductive connection of the grounding hub can be specifically established at this housing, a housing part, or a component which is permanently electrically conductively connected thereto.

Within the scope of the invention, “axial” means an orientation towards a longitudinal axis of the grounding hub or an axis of rotation of a shaft, whereas “radial” means an orientation in the diameter direction from the longitudinal axis of the grounding hub or from the axis of rotation of the shaft.

As set forth in the invention, an “electrically conductive” connection is to be understood as a connection in which a current flow is enabled between the connected components. With respect to the arrangement according to the invention, this electrically conductive connection is formed between the ground and the grounding hub, and between the grounding hub and the component to be grounded, wherein this can be implemented directly via a direct contact in each case or indirectly via further, intermediate components.

Within the arrangement, the grounding hub is also used, however, to supply a lubricant and/or coolant to the component to be grounded, which lubricant and/or coolant is, in particular, oil. For the purpose of supplying the lubricant and/or coolant, at least some sections of the grounding hub are in the form of a tube, by which a supply line is defined, the supply line being axial and thus extending in the longitudinal direction of the grounding hub. This supply line opens at the first axial end, at which the electrically conductive connection of the grounding hub to the component to be grounded is also established, wherein the lubricant and/or coolant can be conducted along the supply line to a mouth of the supply line, such that supply also takes place to the first axial end and thus to the component to be grounded, which is electrically conductively connected here. Therefore, the grounding hub is configured as a tube at least in the region of the first axial end, and thus on the component-to-be-grounded side. In addition to the mouth, which is located at the first axial end, the supply line also preferably has a further mouth, from which the supply line can be supplied with the lubricant and/or coolant.

As set forth in example aspects of the invention, the grounding hub has, in particular, a rod-like shape, i.e., the grounding hub is designed as an elongate component, similarly to a shaft, in order to establish the electrically conductive connection preferably axially between the component to be grounded and the ground within the arrangement according to example aspects of the invention. It is further preferred when the grounding hub is rotationally symmetrical. As described above, the grounding hub is tubular at least over part of the axial extension of the grounding hub in order to form the axially extending supply line and to enable the supply of the lubricant and/or coolant, along this supply line, in the first path to the first axial end.

In addition, a shaft which radially surrounds the grounding hub is provided, the shaft being axially superimposed and/or coaxial at least with the grounding hub. Therefore, the shaft is configured as a hollow shaft at least in the region of the axial overlap. Particularly preferably, the grounding hub extends axially along the entire length of this shaft, which is formed completely as a hollow shaft, and through which the grounding hub radially inwardly extends.

Example aspects of the invention now encompasses the technical teaching that the grounding hub is provided with at least one recess, which connects the supply line to an intermediate space, which is radially delimited between the grounding hub and the shaft and which extends axially to the first axial end. A circumferential damming edge is formed on an inner diameter of the shaft and axially on a side of the at least one recess, which faces away from the first end. By the circumferential damming edge, in interaction with the intermediate space, a second path is formed for conducting lubricant and/or coolant from the supply line via the at least one recess to the first axial end.

In other words, at least one recess is formed in the grounding hub, via which a connection is established between the supply line, which is defined by the grounding hub, and an intermediate space. The intermediate space is defined radially between the grounding hub and the shaft, which radially surrounds the grounding hub and which is axially superimposed and/or coaxial at least with the grounding hub. The radially surrounding shaft is additionally provided with a damming edge axially on a side of the at least one recess, which faces away from the first axial end, the damming edge being formed on an inner diameter of the shaft. This damming edge, together with the intermediate space, ensures that a second path is defined, via which the lubricant and/or coolant, which enters the intermediate space from the supply line via the at least one recess, can flow towards the first axial end.

Such an example embodiment of an arrangement has the advantage that, due to the interaction of the at least one recess with the circumferential damming edge and the intermediate space, supply of the lubricant and/or coolant to the first axial end, and thus to the component to be grounded, which is arranged there, can be improved. This is the case because, as a result, the second path enables supply of the lubricant and/or coolant to the first axial end parallel to the first path, as a result of which sufficient supply to the component to be grounded and, optionally, to further components in this region can be ensured. Via the at least one recess, the lubricant and/or coolant specifically from the supply line, which is formed by the grounding hub, can enter the intermediate space on an inner circumference of the radially surrounding shaft. Due to the circumferential damming edge, the lubricant and/or coolant is prevented from flowing in the axial direction which is counter to the first axial end. In addition, cooling of the radially surrounding shaft can also be achieved. The design of the second path according to example aspects of the invention is advantageous, in particular, when further components, for example, for establishing the electrically conductive connection, are provided at the mouth of the supply line at the first axial end, the further component at least making it difficult for the lubricant and/or coolant to flow via the first path.

In contrast, according to DE 10 2019 133 677 A1, the lubricant and/or coolant is supplied to the rotor shaft to be grounded completely merely via the supply line which is formed by the tubular grounding hub, wherein the grounding element is provided in the mouth area of the supply line on the rotor shaft side, the grounding element obstructing the supply of the lubricant and/or coolant.

In the arrangement according to example aspects of the invention, the at least one recess preferably extends purely radially, the at least one recess being introduced into the grounding hub, in particular, as a radially extending bore. The grounding hub is preferably equipped with precisely one recess. Within the scope of example aspects of the invention, multiple recesses can also be provided, however. In addition to a purely radial extension, the at least one recess within the scope of example aspects of the invention can also have an oblique extension in each case, i.e., an extension in the radial direction and in the axial direction.

According to one example embodiment of the invention, the grounding hub is formed completely as a tube, wherein the supply line extends axially from a second axial end, at which the electrically conductive connection of the grounding hub to the ground is established, to the first axial end and can be supplied with the lubricant and/or coolant from the ground at the second axial end. Advantageously, as a result, supply of the lubricant and/or coolant can be implemented on the ground side by providing an inlet at the second axial end on the end face of the grounding hub, from which inlet the lubricant and/or coolant can flow into the supply line.

According to one example design option of the invention, the at least one recess is situated axially on a side of an external toothing of the shaft, which faces away from the damming edge. A meshing of teeth for coupling the shaft is established via the external toothing of the shaft. This has the advantage that the radially surrounding shaft is therefore reliably cooled in the region of the meshing of teeth via the lubricant and/or coolant which is conducted on the inner circumference of the shaft.

In one example development of the invention, the at least one recess is formed in a region of the grounding hub which is vertically at the top when the grounding hub is in the installed position. As a result, the lubricant and/or coolant flows out via the at least one recess into the intermediate space only once the supply line, which is defined by the grounding hub, is at least largely filled with the lubricant and/or coolant. Therefore, the lubricant and/or coolant can be conducted via the second path only when a back-up arises in the first path.

According to a further example embodiment of the invention, the electrically conductive connection of the grounding hub to the component to be grounded is established at a grounding element, which is inserted into the grounding hub from the first axial end and projects axially with respect to the first axial end with one portion at which the electrically conductive connection to the component to be grounded is established. A passage extends axially through the grounding element, via which the supply line is connected to an end face of the portion. Advantageously, as a result, an electrically conductive connection of the grounding hub with the component to be grounded can be achieved in a reliable way. The grounding element can be configured in the manner of a sliding contact. Within the scope of example aspects of the invention, however, the grounding element can be mounted on the component-to-be-grounded side or on the grounding hub side via a bearing, preferably a roller bearing. Optionally, this bearing can also form the grounding element itself.

The aforementioned bearing, via which a relative rotation of the component to be grounded with respect to the grounding hub can be enabled, can be, in particular, a radial bearing, this radial bearing preferably being configured as a roller bearing and, particularly preferably, as a grooved ball bearing. Within the scope of example aspects of the invention, the intermediate bearing could also be a roller bearing of a different design, such as, for example, a roller bearing, or a plain bearing.

According to a further example design option of the invention, the shaft is connected to the component to be grounded for conjoint rotation. Within the scope of example aspects of the invention, this is the case, in particular, when the component to be grounded is a rotor shaft, which connects the shaft to a rotor of an electric machine for conjoint rotation, the shaft radially surrounding the grounding hub.

Alternatively, preferably in addition to the aforementioned example design option, however, the shaft and the component to be grounded define a collecting chamber between each other, in which collecting chamber the first path and the second path at least predominantly converge. The lubricant and/or coolant which are/is conducted via the two paths therefore converge in this case, wherein the collecting chamber is preferably formed at the first axial end of the grounding hub between the shaft and the component to be grounded.

In a combination of the two aforementioned example variants, the shaft and the component to be grounded are both rotatably mounted via at least one bearing at a bearing point radially external to the corotational connection. The collecting chamber is situated radially no higher than a gap which is formed between the shaft and the component to be grounded, the collecting chamber being connected via the gap spatially at least with a region of the at least one bearing, which is situated vertically underneath the collecting chamber in the installed position. Advantageously, as a result, the at least one bearing, via which the shaft and the component to be grounded are rotatably mounted, can also be supplied with the lubricant and/or coolant from the collecting chamber. Preferably, the at least one bearing is at least one roller bearing. Within the scope of example aspects of the invention, mounting via a plain bearing would also be conceivable.

In one example development of the aforementioned embodiment, a stationary guide element, which is inclined towards the at least one bearing, is provided vertically underneath the gap and vertically above as well as axially next to the at least one bearing in the installed position. As a result, supply of the lubricant and/or coolant to the at least one bearing is improved by way of the lubricant and/or coolant, which flows out of the gap, impacting the guide element and being directed via this guide element towards the at least one bearing.

According to one example embodiment of the invention, the first axial end of the grounding hub is spatially connected to an inner region of the component to be grounded. Therefore, the lubricant and/or coolant, which is directed via the first path and also via the second path to the first axial end, can also reach the inner region of the component to be grounded in order to achieve lubrication and/or cooling here. Particularly preferably, a collecting chamber is provided in the area in front of the inner region of the component to be grounded, in which collecting chamber the two paths converge.

In one development of the aforementioned example embodiment, at least some sections of the component to be grounded, which is in the form of a rotor shaft, have a polygonal outer contour, at which the rotor shaft is connected to a rotor of the electric machine for conjoint rotation. Channels are formed between an inner circumference of the rotor and an outer circumference of the outer contour, each channel being connected to the inner region of the rotor shaft. This has the advantage that the lubricant and/or coolant can then be subsequently conducted also via this connection between the rotor and the rotor shaft, as a result of which a cooling of the rotor of the electric machine can also be improved. In particular, the respective connection of the channels to the inner region of the rotor shaft is established via at least one radial passage. According to one example variant of the invention, the at least one radial passage is configured on the rotor shaft so as to be situated axially next to the rotor. In addition, a ring is arranged on the rotor shaft, which has at least one recess in an inner diameter, via which the at least one radial passage is spatially connected to the channels. Alternatively, the at least one radial passage is provided axially at the level of the rotor. In both cases, a reliable supply of the lubricant and/or coolant from the inner region of the rotor shaft into the channels is achieved. The at least one radial passage is implemented, in particular, as a bore, which is introduced into the rotor shaft so as to extend radially.

In particular, each of the channels opens axially on both sides of the rotor in order to enable the lubricant and/or coolant to flow radially outward and, thus, to cool a winding overhang of the electric machine.

Example aspects of the invention also relate to a transmission, which is, in particular, a motor vehicle transmission. In this transmission, at least one shaft is grounded in an arrangement according to one or more of the aforementioned example variants. This arrangement can be implemented, in particular, with a rotor shaft of an electric machine which is integrated into the transmission. An arrangement according to example aspects of the invention for grounding the shaft can also be an integral part of an electric drive axle unit for a motor vehicle or of an electric machine.

### BRIEF DESCRIPTION OF THE DRAWINGS

Advantageous example embodiments of the invention, which are explained in the following, are shown in the drawings, in which:

FIG. 1 shows a schematic view of a drive train of a motor vehicle;

FIG. 2 shows a sectional view of a transmission of the drive train from FIG. 1 in the region of one part of an arrangement according to example aspects of the invention, according to a first embodiment of the invention;

FIG. 3 shows a sectional view of another part of the arrangement from FIG. 2;

FIG. 4 shows another sectional view of the part of the arrangement from FIG. 3;

FIG. 5 shows a sectional view of one part of an arrangement according to a second example design option of the invention; and

FIG. 6 shows a schematic view of an alternative drive train of a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

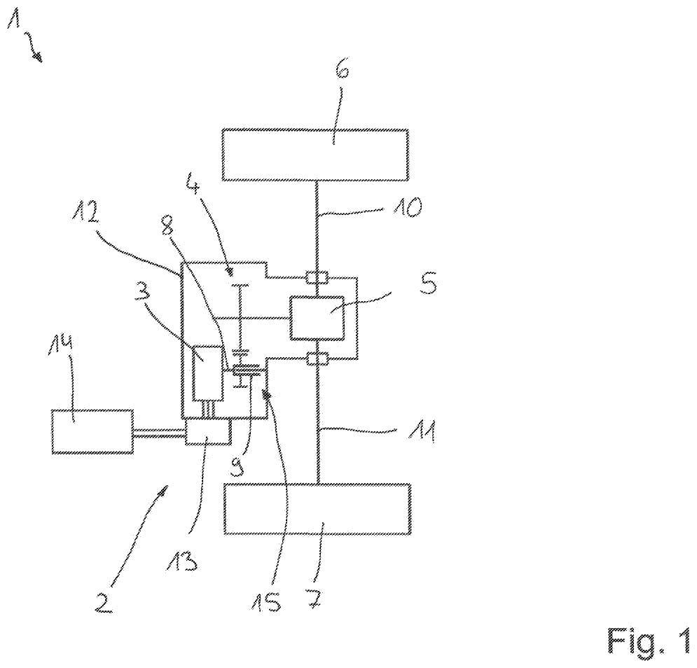

FIG. 1 shows a schematic view of a drive train 1 for a motor vehicle, which is designed as a purely electric drive train. The drive train 1 has an electric axle drive unit 2. The electric drive axle unit 2 includes an electric machine 3, the power of which is transmitted onto driving wheels 6 and 7 of the motor vehicle via a reduction gear set 4 and a differential gear 5. For this purpose, the electric machine 3 is connected at the output end at a rotor shaft 8 to the reduction gear set 4 via a shaft 9. Output shafts 10 and 11 of the differential gear 5 are connected to the driving wheels 6 and 7. The electric machine 3, the reduction gear set 4 and the differential gear 5 are enclosed in one or multiple housing(s) 12. A power inverter 13 is mounted on the housing 12. The power inverter 13 is connected to the electric machine 3 on one side and to a battery 14 on the other side. The power inverter 13 is utilized for converting the direct current of the battery 14 into an alternating current, which is suitable for operating the electric machine 3, and includes several power semiconductors for this purpose. The conversion between direct current and alternating current takes place by a pulse-like operation of the power semiconductors controlled by an open-loop system.

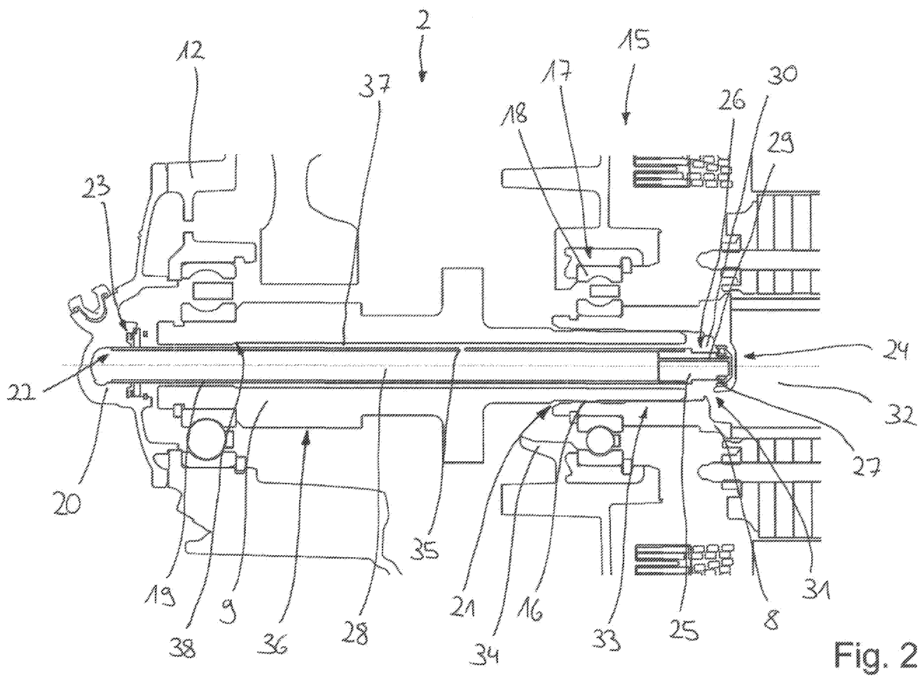

In order to prevent electromagnetic interference and the build-up of a potential difference during operation, the rotor shaft 8 of the electric machine 3 is grounded within the framework of an arrangement 15 which is designed according to a first example embodiment of the invention. One part of the arrangement 15 is shown in FIG. 2, in which arrangement 15 it is also apparent that the multi-piece rotor shaft 8 is connected within the housing 12 to the shaft 9 for conjoint rotation, in order to establish the coupling of the rotor shaft 8 with the reduction gear set 4. The corotational connection between the shaft 9 and the rotor shaft 8 is established at a driving tooth system 16, the shaft 9 and the rotor shaft 8 being jointly rotatably mounted axially in the region of the driving tooth system 16 at a bearing point 17 via a bearing 18, which is a roller bearing in the form of a grooved ball bearing.

In order to ground the rotor shaft 8 at the housing 12, the arrangement 15 includes a stationary grounding hub 19, which electrically conductively connects the rotor shaft 8 to a housing cover 20 of the housing 12, the housing 12 functioning as ground for grounding the rotor shaft 8. The grounding hub 19 is tubular and extends axially from the housing cover 20 through the shaft 9, which is configured as a hollow shaft, into a supporting bore 21 in the rotor shaft 8. The shaft 9 is also inserted into the supporting bore 21. The corotational connection with the shaft 9 is established within the supporting bore 21 via the driving tooth system 16.

The grounding hub 19 is made of an electrically conductive material, which is preferably metal. At one axial end 22, the grounding hub 19 is floatingly mounted in the housing cover 20 and electrically conductively connected thereto via an intermediate guide device 23 (not shown in detail in the present case). A grounding element 25 is introduced into the grounding hub 19 at an end 24, which is opposite the end 22. The grounding element 25 projects with respect to the end 24 with a portion 26, via which a sliding contact is established with the rotor shaft 8 at a base of the supporting bore 21. The grounding element 25 therefore establishes the electrically conductive connection between the stationary grounding hub 19 and the rotating rotor shaft 8. In addition, a bearing 27 in the form of a roller bearing is provided between the portion 26 of the grounding element 25 and the rotor shaft 8.

Apart from the establishment of an electrically conductive connection between the rotor shaft 8 and the housing 12 for grounding the rotor shaft 8, the grounding hub 19 in the arrangement 15 is additionally provided for conducting a lubricant and coolant in the form of oil to the rotor shaft 8. For this purpose, the grounding hub 19, due to the design of the grounding hub 19 as a tube in the inner region, forms a supply line 28, which can be supplied with oil from the housing cover 20 at the end 22, the oil flowing through the supply line 28 from the end 22 in a first path to the end 24. At the end 24, the oil can then flow through the grounding element 25 via at least one passage 29, which extends axially through the grounding element 25. The oil flows from the supply line 28 via the passage 29 and enters a collecting chamber 30, which is delimited between the rotor shaft 8 and the shaft 9.

When the collecting chamber 30 is sufficiently filled, the oil can then flow out of the collecting chamber 30, through a passage 31 and into an inner region 32 of the rotor shaft 8 in order to achieve, from this point onward, in particular, cooling of the rotor shaft 8 and further parts of the electric machine 3.

However, the oil can also escape from the collecting chamber 30 via a gap 33 between the rotor shaft 8 and the shaft 9. The oil can flow along the supporting bore 21 and finally flow radially outwards, where, among other things, the oil impacts a stationary guide element 34, which is provided axially adjacently to the bearing 18. The guide element 34 is inclined towards the bearing 18, such that the oil which impacts the guide element 34 is directed via the guide element 34 towards the bearing 18 and lubricates and cools the bearing 18.

Apart from the first path, the oil can also be conducted into the collecting chamber 30 via a parallel, second path from the end 22 of the grounding hub 19 to the end 24. For this purpose, the grounding hub 19 is provided with a recess 35. When the grounding hub 19 is in the installed position, the recess 35 is situated vertically at the top and axially adjacently to an external toothing 36 of the radially surrounding shaft 9. When the supply line 28 is essentially completely filled, the oil can escape from the supply line 28 via the recess 35 and enter an intermediate space 37, which is radially delimited between an outer circumference of the grounding hub 19 and an inner circumference of the shaft 9.

In the intermediate space 37, the oil then flows vertically downward onto the rotating shaft 9 and can then flow along the inner circumference of the rotating shaft 9 towards the axial end 24 of the grounding hub 19 and then into the collecting chamber 30, which is located here. The oil is prevented from flowing back towards the axial end 22 via a damming edge 38, which is circumferentially formed on the inner circumference of the shaft 9. The toothing 36 of the shaft 9 is situated axially between the recess 35 and the damming edge 38, as a result of which the oil, which flows towards the damming edge 38 and is prevented from flowing further via the damming edge 38, provides internal cooling of the toothing 36.

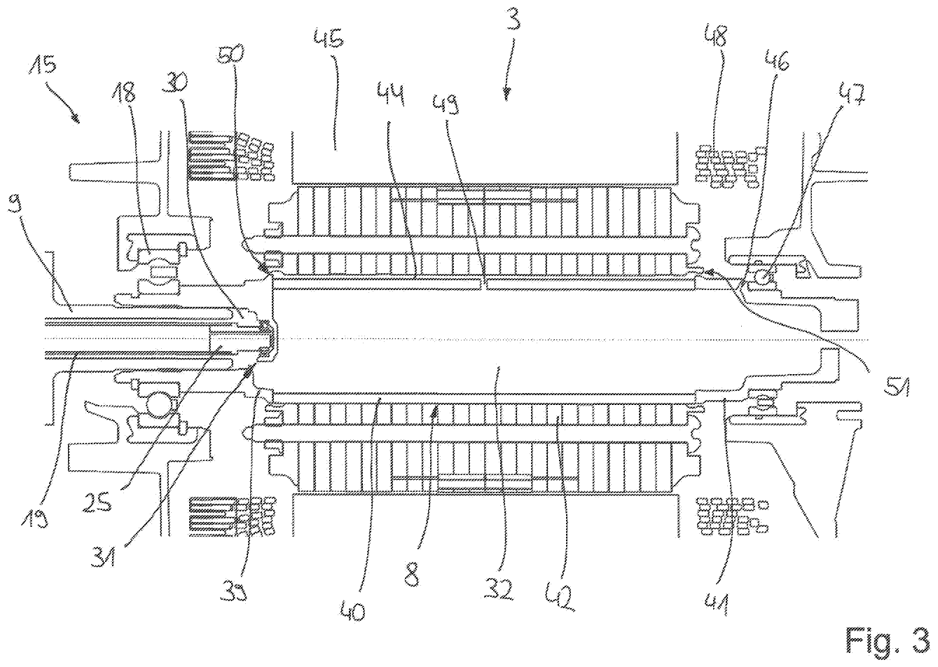

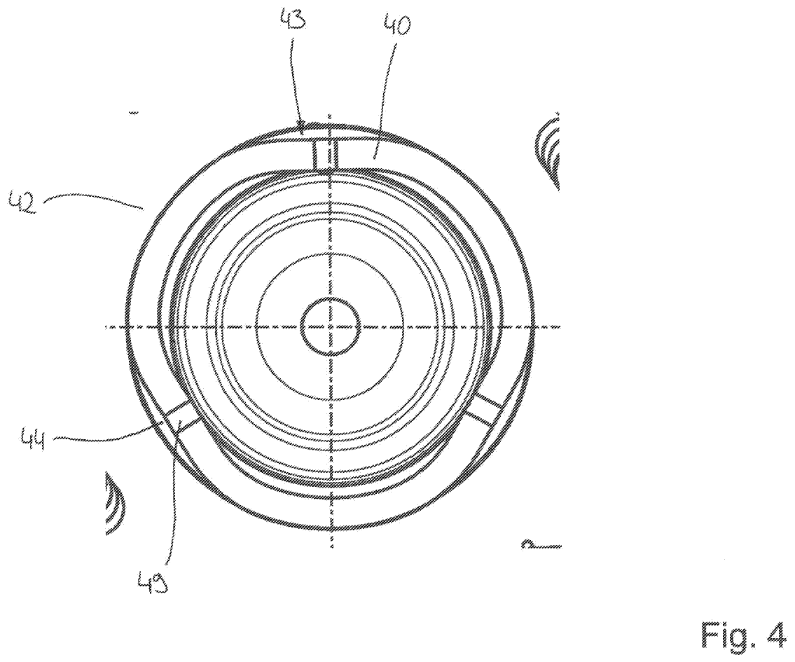

In FIGS. 3 and 4, furthermore, the region of the arrangement 15 following the collecting chamber 30 in the flow direction of the oil is shown in further sectional views. As is apparent, in particular, in FIG. 3, the rotor shaft 8 includes multiple shaft parts 39, 40 and 41, which are connected to one another for conjoint rotation. The corotational connection with the shaft 9 is established and the mounting via the bearing 18 is implemented at the shaft part 39. The shaft part 39 is then followed by the shaft part 40, which, together with the subsequent shaft part 41, essentially defines the inner region 32 of the rotor shaft 8 and is connected at an outer circumference to a rotor 42 of the electric machine 3. The shaft part 40 has a polygonal outer contour, which is apparent in FIG. 4 and, together with the surrounding rotor 42, defines multiple intermediate channels 44. In addition, a stator 45 of the electric machine 3 radially surrounds the rotor 42.

The oil which has flown from the collecting chamber 30 via the passage 31 into the inner region 32 is initially utilized in the flow direction for cooling the inner region 32 of the rotor shaft 8. Furthermore, the oil can then escape from the inner region 32 via at least one passage 46, which is formed in the shaft part 41, which is attached to the shaft part 40 on a side of the shaft part 40 facing away from the shaft part 39. The oil flowing radially outwards via the passage 46 due to the rotation of the rotor shaft 8 is initially supplied to a further bearing 47, via which, in addition the bearing 18, the rotor shaft 8 is rotatably mounted. After the bearing 47 has been lubricated, the oil is then discharged further radially outwards for cooling a winding overhang 48 on one first axial side of the stator 45.

However, the oil can then escape from the inner region 32 via multiple passages 49, each of which is formed as a radially extending bore in the shaft part 40 and is situated axially at the level of the rotor 42. These passages 49 each open into the channels 44 in order to cool the rotor shaft 8 radially from the outside and the rotor 42 radially from the inside via the oil which is conducted in the channels 44. Furthermore, the oil can escape from the channels 44 axially on both sides of the rotor 42 to cool the winding overhang 48 of the stator 45 via mouths 50 and 51, each of which is defined between the rotor 42 and the shaft part 39 and the shaft part 41, respectively.

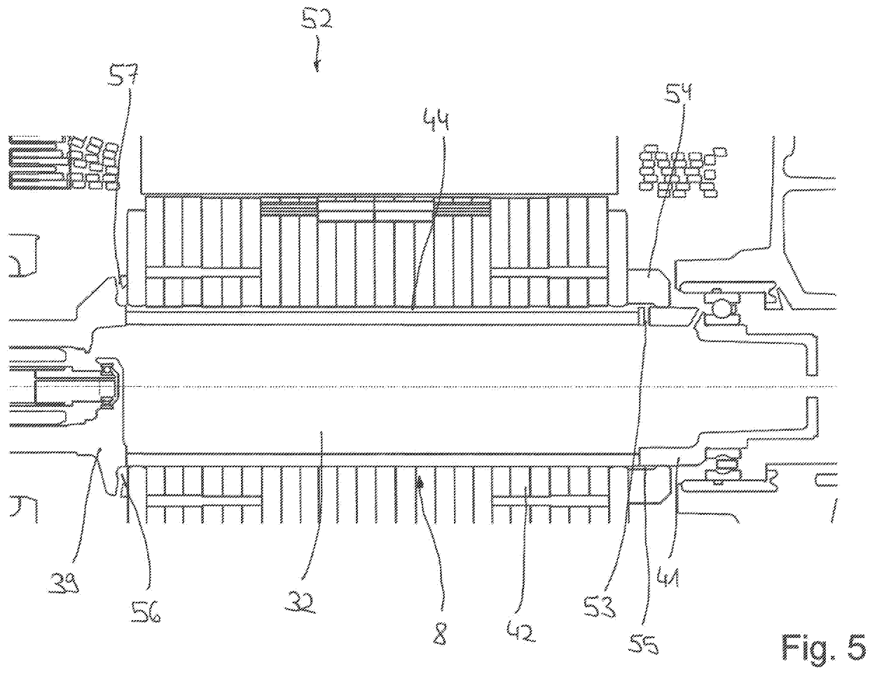

Furthermore, FIG. 5 shows one part of an arrangement 52 according to a second example design option of the invention, which essentially corresponds to the preceding example variant according to FIGS. 2 through 4. In contrast to the preceding example variant, at least one passage 53 is configured in the shaft part 41 of the rotor shaft 8, the passage 53 extending radially and opening at a region of an outer circumference of the shaft part 41. In this region, a ring 54 is pressed onto the shaft part 41. This ring 54 is provided with a circumferential recess 55 on an inner diameter and thus on the shaft part 41 side, via which recess 55 the passage 53 is spatially connected to the channels 44. Consequently, the oil which is discharged from the inner region 32 of the rotor shaft 8 via the passage 53 is diverted into the channels 44 and, there, cools the rotor shaft 8 radially from the outside and cools the rotor 42 radially from the inside. On a side of the rotor 42, which is axially opposite the ring 54, the channels 44 are then each connected to a space 56, which is delimited between the shaft part 39 and the rotor 42. The oil can then flow out radially outwards of this space 56 further via passages 57 in order to cool the winding overhang 48 there. Otherwise, the example design option according to FIG. 5 corresponds to the example variant according to FIGS. 2 through 4, and therefore reference is made to the description thereof.

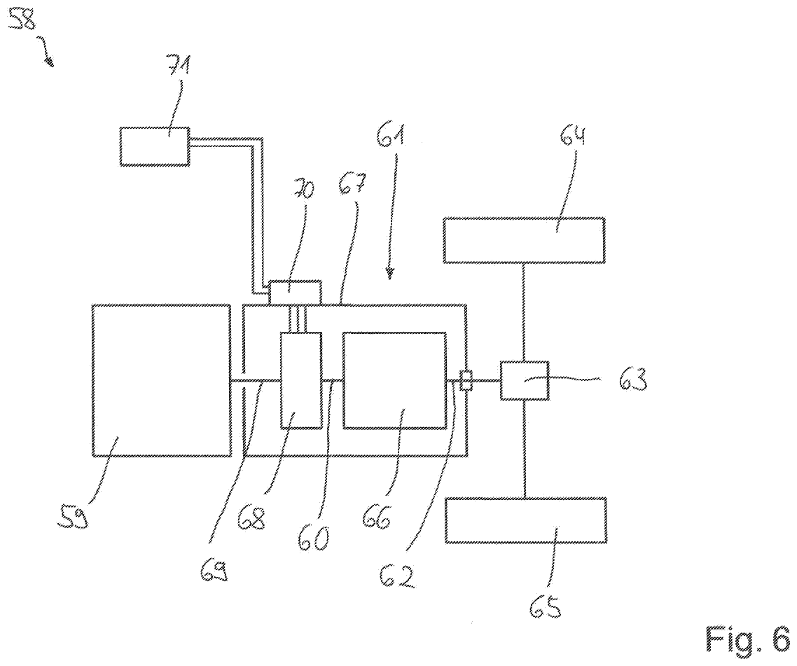

Finally, FIG. 6 shows a schematic view of a drive train 58 for a motor vehicle. This drive train 58 includes an internal combustion engine 59, the output side of which is coupled to an input shaft 60 of a transmission 61. An output shaft 62 of the transmission 61 is connected to a differential gear 63. The differential gear 63 is designed to distribute the power applied at the output shaft 62 to driving wheels 64 and 65 of the motor vehicle. The transmission 61 has a gear set 66, which, together with shift elements which are not shown in FIG. 6, is designed to provide different transmission ratios between the input shaft 60 and the output shaft 62.

The gear set 66 is enclosed in one or more housing(s) 67, which also accommodate(s) an electric machine 68, which is connected to the input shaft 60. The electric machine 68 is designed to drive a rotor shaft 69, which connects the output side of the internal combustion engine 59 to the input shaft 60. A power inverter 70 is mounted on the housing 67. The power inverter 70 is connected to the electric machine 68 on one side and to a battery 71 on the other side. The power inverter 70 is utilized for converting the direct current of the battery 71 into an alternating current, which is suitable for operating the electric machine 68, and includes several power semiconductors for this purpose. The conversion between direct current and alternating current takes place by a pulse-like operation of the power semiconductors controlled by an open-loop system.

In the present case, a grounding of the shaft 69 is carried out within the framework of an arrangement according to example aspects of the invention, the arrangement being produced similarly to one of the example variants according to FIG. 6. Reference is therefore made to the descriptions of FIGS. 2 through 6 for a more precise configuration of the example arrangement for grounding the rotor shaft 69.

By the designs of an arrangement according to example aspects of the invention, a reliable supply of lubricant and/or coolant to a component to be grounded can be achieved.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 drive train
2 axle drive unit
3 electric machine
4 reduction gear set
5 differential gear
6 driving wheel
7 driving wheel
8 rotor shaft
9 shaft
10 output shaft
11 output shaft
12 housing
13 power inverter
14 battery
15 arrangement
16 driving tooth system
17 bearing point
18 bearing
19 grounding hub
20 housing cover
21 supporting bore
22 end
23 guide device
24 end
25 grounding element
26 portion
27 bearing
28 supply line
29 passage
30 collecting chamber
31 passage
32 inner region
33 gap
34 guide element
35 recess
36 external toothing
37 intermediate space
38 damming edge
39 shaft part
40 shaft part
41 shaft part
42 rotor
43 outer contour
44 channels
45 stator
46 passage
47 bearing
48 winding overhang
49 passages
50 mouths
51 mouths
52 arrangement
53 passage
54 ring
55 recess
56 space
57 passages
58 drive train
59 internal combustion engine
60 input shaft
61 transmission
62 output shaft
63 differential gear
64 driving wheel
65 driving wheel
66 gear set
67 housing
68 electric machine
69 rotor shaft
70 power inverter
71 battery

1-17. (canceled)

18. An arrangement (15; 52) for grounding a component, comprising:
a shaft (9);
a grounding hub (19) that electrically conductively connects the component with a ground, the grounding hub (19) electrically conductively connected to the component at a first axial end (24) of the grounding hub (19), at least some sections of the grounding hub (19) being tubular and forming an axially extending supply line (28) that opens at the first axial end (24), fluid being flowable through the axially extending supply line (28) in a first path to the first axial end (24), the grounding hub (19) arranged radially inwardly of the shaft (9),
wherein the shaft (9) is arranged coaxially at least with the grounding hub (19),
wherein the grounding hub (19) comprises at least one recess (35) that connects the supply line (28) to an intermediate space (37) radially delimited between the grounding hub (19) and the shaft (9) and extending axially to the first axial end (24), and
wherein a circumferential damming edge (38) is formed on an inner diameter of the shaft (9) and axially on a side of the at least one recess (35) that faces away from the first end (24),
the circumferential damming edge (38), in interaction with the intermediate space (37), forming a second path for conducting fluid from the supply line (28) via the at least one recess (35) to the first axial end (24).

19. The arrangement (15; 52) of claim 18, wherein:
the component comprises a rotor shaft (8) of an electric machine (3); and
the ground comprises a housing (12).

20. The arrangement (15; 52) of claim 18, wherein:
the grounding hub (19) corresponds to a tube;
the supply line (28) extends axially from a second axial end (22) to the first axial end (24) and is suppliable with the fluid from the ground at the second axial end (22); and
the electrically conductive connection of the grounding hub (19) to the ground established at the second axial end (22) of the grounding hub (19).

21. The arrangement (15; 52) of claim 18, wherein the at least one recess (35) is disposed axially on a side of an external toothing (36) of the shaft (9) that faces away from the damming edge (38), the external toothing (36) configured to establish a coupling to the shaft (9).

22. The arrangement (15; 52) of claim 18, wherein the at least one recess (35) is disposed at a top portion of the grounding hub (19) when the grounding hub (19) is in an installed position.

23. The arrangement (15; 52) of claim 18, wherein the electrically conductive connection of the grounding hub (19) to the component is established at a grounding element (25) inserted into the grounding hub (19) from the first axial end (24) and projecting axially relative to the first axial end (24) at a portion (26) of the grounding element (25) that establishes the electrically conductive connection to the component, wherein a passage (29) extends axially through the grounding element (25) and via which the supply line (28) is connected to an end face of the portion (26) of the grounding element (25).

24. The arrangement (15; 52) of claim 18, wherein the shaft (9) is connected to the component for conjoint rotation.

25. The arrangement (15; 52) of claim 18, wherein the shaft (9) and the component define a collecting chamber (30) therebetween, the first path and the second path at least predominantly converge at the collecting chamber.

26. The arrangement (15; 52) of claim 25, wherein:
the shaft (9) is connected to the component for conjoint rotation;
the shaft (9) and the component are both rotatably mounted via at least one bearing (18) at a bearing point (17) radially external to a corotational connection;
the collecting chamber (30) is situated radially no higher than a gap (33) formed between the shaft (9) and the component; and
the collecting chamber (30) is connected via the gap (33) with a region of the at least one bearing (18) situated vertically underneath the collecting chamber (30).

27. The arrangement (15; 52) of claim 26, further comprising a stationary guide element (34) inclined towards the at least one bearing (18), the stationary guide element (34) disposed vertically underneath the gap (33), the stationary guide element (34) disposed vertically above and axially next to the at least one bearing (18).

28. The arrangement (15; 52) of claim 18, wherein the first axial end (24) of the grounding hub (19) is spatially connected to an inner region (32) of the component.

29. The arrangement (15; 52) of claim 28, wherein:
the component comprises a rotor shaft (8) of an electric machine (3);
at least some sections of the rotor shaft (8) have a polygonal outer contour, at which the rotor shaft (8) is connected to a rotor (42) of the electric machine (3) for conjoint rotation; and
a plurality of channels (44) are formed between an inner circumference of the rotor (42) and an outer circumference of the outer contour (43), each channel being connected to the inner region (32) of the rotor shaft (11).

30. The arrangement (15; 52) of claim 29, wherein a respective connection of the channels (44) to the inner region (32) of the rotor shaft (8) is established via at least one radial passage (49; 53).

31. The arrangement (52) of claim 30, wherein:
the at least one radial passage (53) is arranged on the rotor shaft (8) axially next to the rotor (42);
a ring (54) is arranged on the rotor shaft (8); and
the rotor shaft (8) comprises at least one recess (55) in an inner diameter of the the rotor shaft (8), the at least one radial passage (53) connected to the channels (44) via the at least one recess (55).

32. The arrangement (15) of claim 30, wherein the at least one radial passage (49) is provided axially at a level of the rotor (42).

33. A transmission (61), comprising at least one shaft that is grounded with the arrangement of claim 18.

34. An electric drive axle unit (2) for a motor vehicle, comprising a shaft grounded with the arrangement of claim 18.

35. An electric machine (3), comprising:
a rotationally fixed stator (45); and
a rotatable rotor (42) coupled to a rotor shaft (8),
wherein the rotor shaft (8) is grounded with the arrangement (15; 52) of claim 18.
